(19) United States
(12) Patent Application Publication
(10) Pub. No.: US 2011/0315747 A1
(43) Pub. Date: Dec. 29, 2011

(54) SOLDER BALL MOUNTING APPARATUS, SOLDER BALL MOUNTING METHOD, AND METAL BALL MOUNTING APPARATUS

(75) Inventors: Kenji YAMAMOTO, Kyoto (JP); Yukiko YOSHIMURA, Osaka (JP)

(73) Assignee: PANASONIC CORPORATION, Osaka (JP)

(21) Appl. No.: 13/220,039

(22) Filed: Aug. 29, 2011

Related U.S. Application Data
(63) Continuation of application No. PCT/JP2010/000025, filed on Jan. 5, 2010.

(30) Foreign Application Priority Data
Mar. 19, 2009 (JP) 2009-068940

(51) Int. Cl. B23K 1/20; B23K 3/06

(52) U.S. Cl. 228/248.1; 228/41

(57) ABSTRACT

A solder ball mounting apparatus includes a hopper, a mounting head provided at a tip of the hopper, and a pressing pin which is insertable inside the hopper and the mounting head. The mounting head has an inner diameter which restricts movement of solder balls, and when one of the solder balls is supplied to the mounting head through the hopper, the pressing pin presses one of the solder balls, thereby mounting the solder balls one by one on a target member.

### CROSS-REFERENCE TO RELATED APPLICATION

This is a continuation of PCT International Application PCT/JP2010/000025 filed on Jan. 5, 2010, which claims priority to Japanese Patent Application No. 2009-068940 filed on Mar. 19, 2009. The disclosures of these applications including the specifications, the drawings, and the claims are hereby incorporated by reference in their entirety.

### BACKGROUND

The present disclosure relates to solder ball mounting apparatuses, solder ball mounting methods, and metal ball mounting apparatuses used for die bonders, etc. which are manufacturing facilities of semiconductor devices.

In packages, such as a power transistor, for which high temperature resistance is required, a bonding process by a solder material has been generally used for fixing chips. In a die bonder, assuming that supplying chips one by one to perform a solder bonding process is a model, a supply using a solder wire or a solder ribbon, or a potting using a dispenser, etc. is generally used as a method of supplying a solder material.

However, the supply of the solder material by using the solder wire or the solder ribbon causes variation of the amount of coating due to instability of a supply amount of the solder material. Even when a dispenser is used to achieve constant supply, a reduced amount of supply results in variation in the amount of coating due to variations in supplied amount of the solder material.

Although a solder ball has been used as a solder material since the supply amount of the solder ball is measured in advance and the supply amount of the solder ball is stable, its supplying method has a problem. Manually picking up the solder ball by using tweezers, etc. is not suitable for mass production since operating efficiency and operating precision are reduced, and means for automatically picking up the solder ball have been commercialized.

FIG. 4 shows a conventional solder ball supplying apparatus. For example, Japanese Patent Publication No. 2003-243440 shows a solder ball supplying apparatus for aligning the solder balls 19 by a hopper 20 containing them to take out the solder balls 19 one by one as shown in FIG. 4, not to take out the solder balls one by one by a capillary.

The hopper 20 has a cover 21 capable of being freely opened or closed and including multiple air vents 21a therein. The hopper 20 is formed in a funnel shape, or an inverted hollow conical shape, and the tip of the hopper 20 has a cylindrical linear portion 20a in which the solder balls 19 are aligned. A separator 22 having a recessed portion 22a containing one of the solder balls 19 is positioned directly under the cylindrical linear portion 20a with a gap L having an arbitrary length therebetween, and is mounted on a slide table 23, and the solder balls 19 are intermittently taken out one by one by a driving device 24 provided separately. Therefore, even if the solder balls 19 are attached to one another due to charge, such as static charge or the like, the solder balls 19 can reliably be taken out one by one by the separator 22.

FIG. 5 shows a method of carrying by a handling robot 26 the solder balls 19 separated by the separator 22 to a position to be mounted. The handling robot 26 has an adhesion nozzle 25, and a flexible tube for applying vacuum pressure and air pressure is connected to the rear end portion of the adhesion nozzle 25. Each of the solder balls 19 is moved to point b above the slide table 23, and is picked up by the tip of the adhesion nozzle 25. In other words, the adhesion nozzle 25 has moved directly on the solder ball 19 is vertically moved by the handling robot 26 as shown in arrow B, and sucks the solder ball 19 with a vacuum pressure. Next, the handling robot 26 pivots as shown in arrow C, and the solder ball 19 is moved from point b to point a with distance W2 which is optionally fixed. The handling robot 26 vertically moves as shown in arrow D, and mounts the solder ball 19 in a predetermined position in, e.g., a lead frame.

### SUMMARY

Japanese Patent Publication No. 2003-243440 proposes a method of taking out the solder balls 19 one by one so that excess solder balls 19 are not attached to a capillary due to static charge, etc.

However, each of the solder balls 19 has fine projections on the surface thereof when they are manufactured, and therefore, when the solder balls 19 are aligned in one line, the alignment of them may cause in some cases a problem that the fine projections are scratched on the surface of an adjoining solder ball 19, and if they are forcibly peeled off, the fine projections may be peeled off from the solder ball 19. Furthermore, the peeling off of the fine projections reduces the weight of the solder ball 19, and becomes a factor in variation of the coating amount of the solder material, and there may be a problem of pollution of surroundings due to fine particles. Therefore, it is necessary to provide a mechanism in which the solder balls 19 are separated one by one without adjoining each other.

In prior art techniques, when the solder balls 19 aligned in one line by the hopper 20 are taken out one by one by the separator 22, one of the solder balls 19 to be taken out and another one of the solder balls 19 placed directly thereon always adjoin each other, and if the adjoining portion has fine projections, the solder ball 19 may be peeled off at the fine projections as a boundary.

On one solder ball 19 to be taken out from the hopper 20, the weight of another solder ball 19 placed directly on the one solder ball 19 is applied, and therefore, when the one solder ball 19 is taken out, a structure of mechanically holding the another solder ball 19 placed directly on the one solder ball 19 is needed. If there is no mechanism for holding the solder ball 19, after the separator 22 is moved, the next solder ball 19 falls to contact the surface of the separator 22 since there is a gap L, as shown in FIG. 4, and when the separator 22 moves back to the original position, friction occurs between the solder ball 19 and the surface of the separator 22. The solder ball 19 may be destroyed due to the friction in some cases. In order to prevent the above problems, a holding mechanism for feeding the solder balls 19 one by one is needed at an extraction portion located at the tip of the hopper 20.

The solder ball 19 taken out by the separator 22 is mounted in a predetermined position by the handling robot 26, and therefore, it is necessary to provide the hopper 20, the separator 22, and the handling robot 26. In other words, a complicated mechanism is adopted, where an extraction mechanism of the solder balls 19 and a mounting mechanism have to be separately controlled.

Furthermore, after the solder ball 19 is mounted, there is a problem that the mounted solder ball 19 rolls or the position thereof is shifted. The problem occurs because, even though the solder ball 19 is mounted on a lead frame, it is simply mounted on the frame, and therefore, for example, in a step of pitch-feeding the lead frame, the solder ball 19 rolls to be shifted from the mounted position, and to fall from the lead frame.

In view of the above problems, it is an object of the present invention to reliably and precisely mount solder balls one by one in mounting positions, and to be able to temporarily hold the solder balls so that the mounted solder balls do not roll.

Of the object of reliably mounting the solder balls, and the object of preventing the mounted solder ball from rolling, at least any one of them may be achieved.

In order to attain the above objects, the present invention is configured to supply solder balls one by one to a mounting head.

Specifically, a solder ball mounting apparatus according to the present invention includes a hopper, a mounting head provided at the tip of the hopper, and a pressing pin which is insertable inside the hopper and the mounting head, wherein the mounting head has an inner diameter which restricts movement of solder balls, and when one of the solder balls is supplied to the mounting head through the hopper, the pressing pin presses the one of the solder balls, thereby mounting the solder balls one by one on a target member.

According to the solder ball mounting apparatus, the solder balls can be reliably and precisely mounted one by one in mounting positions, and the pressing pin presses the solder ball on the target member to melt the solder ball, thereby temporarily holding the solder ball. With this structure, the solder balls are unlikely to roll or the positions of the solder balls are unlikely to be shifted after they are mounted, and therefore, the solder balls can reliably be mounted on the target member.

In the solder ball mounting apparatus of the present invention, the central positions of the hopper, the mounting head, and the pressing pin may be identical with one another.

In the solder ball mounting apparatus of the present invention, the pressing pin may be formed so as to close an inside of the hopper when the pressing pin goes down.

In this case, the pressing pin may be formed in a tapered shape so that a diameter of the pressing pin is smaller at a side of the mounting head.

The solder ball mounting apparatus of the present invention may further include a gas supply means configured to supply nitrogen gas to the hopper.

The solder ball mounting apparatus of the present invention may further include an attachment block configured to attach the hopper, and a heater provided in the attachment block.

A solder ball mounting method according to the present invention includes: allowing a pipe having an inner diameter which restricts movement of solder balls to pass one of the solder balls; mounting the one of the solder balls having passed through the pipe in a mounting position in a target member; pressing the mounted solder ball from an inside of the pipe; and after the pressing the mounted solder ball, melting the solder ball to solder the target member.

According to the solder ball mounting method of the present invention, the solder balls can be reliably and precisely mounted one by one in the predetermined mounting positions. Besides, the pressing pin presses the solder ball on the target member to melt the solder ball, thereby temporarily holding the solder ball, and therefore, the solder balls can be mounted so that the solder balls are unlikely to roll or the positions of the solder balls are unlikely to be shifted after they are mounted.

A metal ball mounting apparatus according to the present invention includes: a first mechanism configured to supply metal balls to a target member; a second mechanism configured to supply the metal balls to the first mechanism; and a third mechanism configured to supply the metal balls to the second mechanism, wherein the third mechanism is controlled to, when the second mechanism includes no metal ball, supply only one new metal ball.

According to the metal ball mounting apparatus, the third mechanism is controlled to, when the second mechanism includes no metal ball, supply only one new metal ball. Therefore, the metal balls are unlikely to roll or the positions of the metal balls are unlikely to be shifted after they are mounted, and the metal balls can reliably mount the metal balls on the target member.

It is preferable that the metal ball mounting apparatus is provided between the first mechanism and the second mechanism, and further includes a fourth mechanism configured to temporarily stop the supply of the metal balls.

In this case, the first mechanism may have a cylindrical shape with a fixed inner diameter.

In this case, the fourth mechanism may be a cylindrical pin which is insertable inside the first mechanism.

In this case, the fourth mechanism may be provided to be vertically movable along the first mechanism.

In this case, it is preferable that the fourth mechanism is controlled to be pulled out from the first mechanism when the target member is disposed under the first mechanism.

In this case, it is preferable that the fourth mechanism is controlled to be inserted into the first mechanism when the metal ball is supplied to the target member.

Furthermore, in this case, it is preferable that the fourth mechanism is controlled to press the metal ball from the above after the metal ball is supplied.

In this case, the second mechanism may have a mortar shape so that the inner diameter thereof becomes smaller downwardly.

In this case, the central positions of the first mechanism, the second mechanism, and the fourth mechanism may be identical with one another.

In this case, it is preferable that the metal ball mounting apparatus further includes a fifth mechanism having a cylindrical shape, and provided at the tip of the first mechanism, and the inner diameter of the fifth mechanism is smaller than that of the first mechanism.

In this case, a part of the fourth mechanism may be formed in a tapered shape so that a diameter of a tip of the fourth mechanism facing the target member becomes smaller.

Furthermore, in this case, the metal ball mounting apparatus may further include a sixth mechanism configured to supply gas to the first mechanism and the second mechanism.

According to the solder ball mounting apparatus, the solder ball mounting method, and the metal ball mounting apparatus, solder balls which are metal balls can be reliably and precisely mounted one by one in predetermined mounting positions. Besides, the pressing pin presses the solder ball on the target member to melt the solder ball, thereby temporarily holding the solder ball, and therefore, the solder balls are unlikely to roll or the positions of the solder balls are unlikely to be shifted after they are mounted. By replacing components of the solder ball mounting apparatus depending on a size of the diameter of the solder ball, it is possible to deal with various solder balls, and the solder balls are not conveyed by vacuum adhesion, the solder balls are unlikely to drop during the conveyance, and it is unnecessary to deal with clogging of a vacuum filter, etc. due to dust of fragments and the like of the solder balls.

### BRIEF DESCRIPTION OF THE DRAWINGS

FIG. 1 is a cross-sectional view of a main part of a solder ball mounting apparatus according to one embodiment of the present invention.

FIG. 2A is a side view of an exemplary configuration of the solder ball mounting apparatus according to the embodiment of the present invention, and FIG. 2B is a front view of the exemplary configuration of the solder ball mounting apparatus according to the embodiment of the present invention.

FIGS. 3A-3D are cross-sectional views illustrating steps of a solder ball mounting method according to the embodiment of the present invention in the sequence in which a solder ball is mounted.

FIG. 4 is a cross-sectional view of a conventional solder ball supplying apparatus.

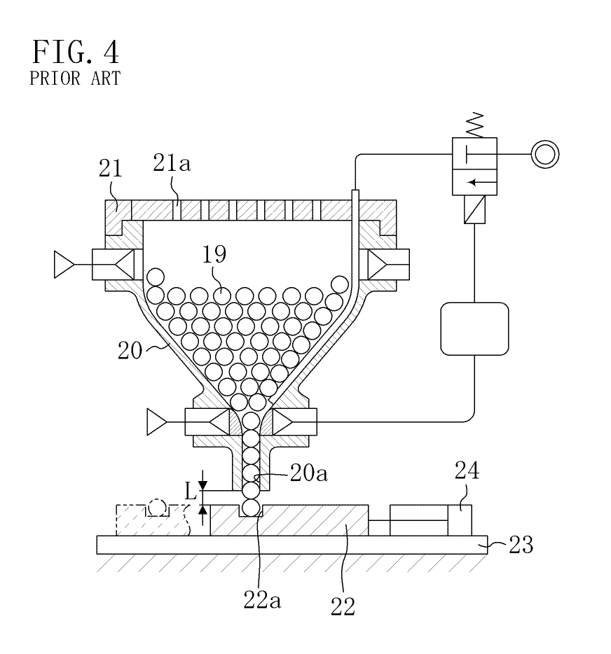

FIG. 5 is a cross-sectional view of a conventional solder ball handling apparatus.

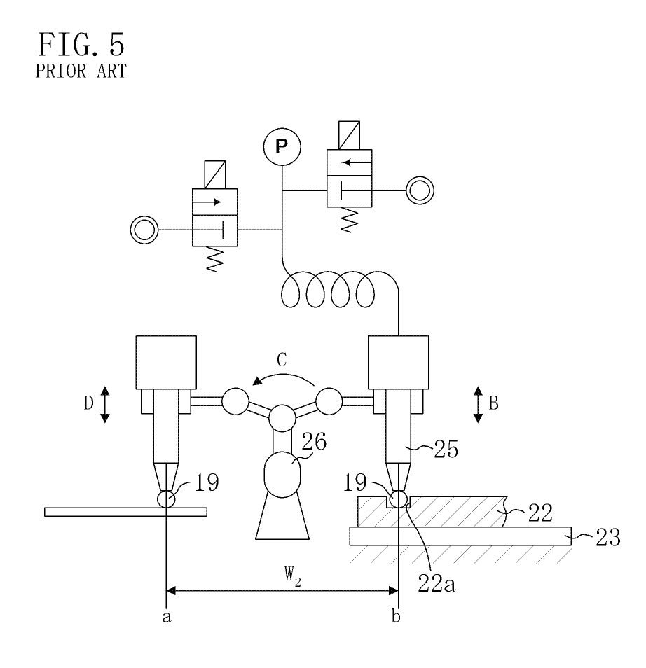

### DETAILED DESCRIPTION

A solder ball mounting apparatus according to one embodiment of the present invention will be described with reference to the accompanying drawings.

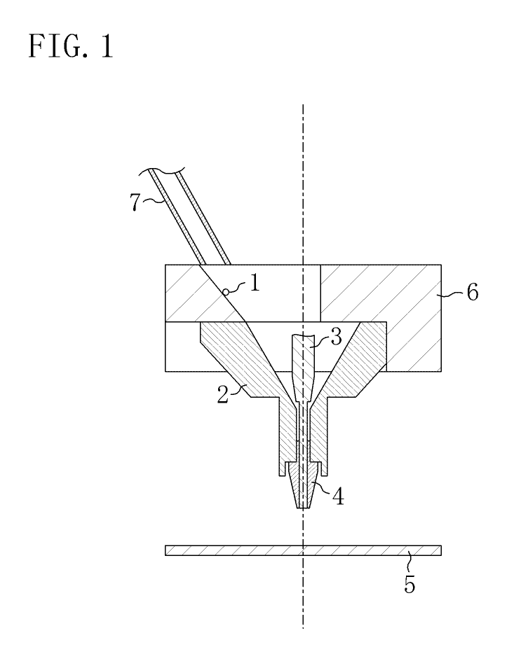

FIG. 1 shows a cross-sectional structure of a main part of the solder ball mounting apparatus according to the embodiment of the present invention.

A hopper 2 is formed in a funnel shape, or an inverted hollow conical shape, and a mounting head 4 is attached to the tip (lower end) of the hopper 2. A pressing pin 3 is insertable inside the hopper 2 and the mounting head 4. The pressing pin 3, the hopper 2, and the mounting head 4 are precisely attached to an attachment block 6 so that the central positions of the pressing pin 3, the hopper 2, and the mounting head 4 are identical with one another.

A through pipe 7 is connected to the attachment block 6, and solder balls 1 are supplied one by one to the attachment block 6. When the pressing pin 3 falls, the solder ball 1 is blocked by the pressing pin 3, and is not supplied to the bottom portion of the hopper 2 and the mounting head 4. When the pressing pin 3 rises, the solder ball 1 passes through the hopper 2, rolls along the inner wall of the mounting head 4, and arrives at the tip of the mounting head 4. The solder ball 1 is controlled by the inner wall of the mounting head 4, and precisely arrives at a mounting position. Since the tip of the pressing pin 3 has a tapered shape, the pressing pin 3 has a structure of not catching the solder ball 1 when it rises. After the solder ball 1 arrives at a mounting position, the pressing pin 3 presses the solder ball 1 on a lead frame 5 which is a target member, and facilitates melting of the solder ball 1, thereby temporarily holding the solder ball 1.

In this embodiment, a sensor is installed in the through pipe 7, and it detects whether one of the solder balls 1 reliably has passed. It is preferable that, when multiple ones of the solder balls 1 are supplied, the apparatus is stopped to prevent the multiple ones of the solder balls 1 from being supplied.

The hopper 2 is precisely fixed to the attachment block 6 with a hollow set screw, etc., and since the central positions of the pressing pin 3, the hopper 2, and the mounting head 4 are identical with one another, even if some components are replaced, the positioning accuracy is precisely reproduced. The mounting head 4 is fixed to the hopper 2 with a screw fastener, and therefore, by replacing the mounting head 4 with another one having an inner diameter different from the inner diameter of the mounting head 4, it is applicable to deal with solder balls having diameters different from that of the solder ball 1.

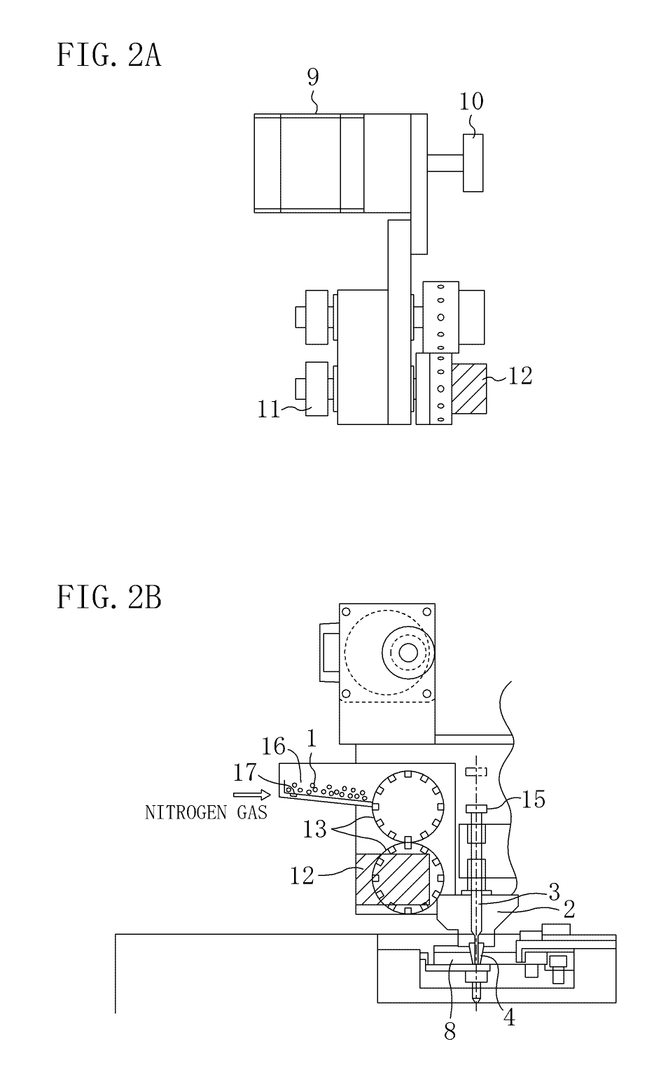

FIGS. 2A and 2B show an exemplary configuration of the solder ball mounting apparatus according to the embodiment of the present invention.

Drums 13 are connected to an upper part of the hopper 2 including the pressing pin 3 and the mounting head 4 therein. The drums 13 are also connected to a solder ball tank 16 filled with multiple ones of the solder balls 1, and the solder ball tank 16 is provided with a sensor 17 for the amount of solder balls which detects low amounts of the solder balls 1.

In the outer circumferences of the drums 13, recessed portions each of which contains one of the solder balls 1 are concentrically disposed, a pulse motor 9 for intermittently rotating the drum 13, and timing pulleys 10 and 11 are provided. One of the drums 13 feeding the solder ball 1 is rotated, and then, the solder balls 1 are lifted up one by one from the solder ball tank 16. At a side of the feeding drum 13, a ball sensor 15 for sensing presence of the solder ball is provided, and it checks whether the solder ball 1 is supplied on the feeding drum 13. If the solder ball 1 is not supplied, the pulse motor 9 is further intermittently rotated to supply the solder ball 1. By the intermittent rotation, the solder ball 1 is conveyed to the other drum 13 facing the feeding drum 13 and synchronized with the feeding drum 13 by the timing pulleys 10 and 11. Nitrogen gas is injected into the inside of the solder ball mounting apparatus, thereby preventing the solder ball 1 from being oxidized.

The other drum 13 receiving the solder ball 1 is provided with a pre-heater 12, and the solder ball 1 is heated by the pre-heater 12. The solder balls 1 having been sufficiently heated are supplied one by one to the solder ball mounting apparatus by intermittent rotation. As a method of supplying the solder balls 1, a method of taking out the solder balls 1 one by one by using a part feeder or a line feeder may be used. The periphery of the mounting head 4 is covered by a heat insulator 8, thereby preventing a temperature in a furnace from being decreased when the mounting head 4 vertically moves. With this structure, it is possible to shorten a time during which the solder ball 1 melts.

According to the solder ball mounting apparatus regarding the embodiment, the solder balls can be reliably and precisely mounted one by one in the predetermined mounting positions, and can be temporarily held at the same time, thereby making it possible to mount the solder balls 1 so that the solder balls 1 are unlikely to roll or the positions of the solder balls 1 are unlikely to be shifted after they are mounted. Furthermore, the components of the solder ball mounting apparatus are easily replaced with other ones, thereby making it possible to easily deal with solder balls having diameters different from that of the solder ball 1.

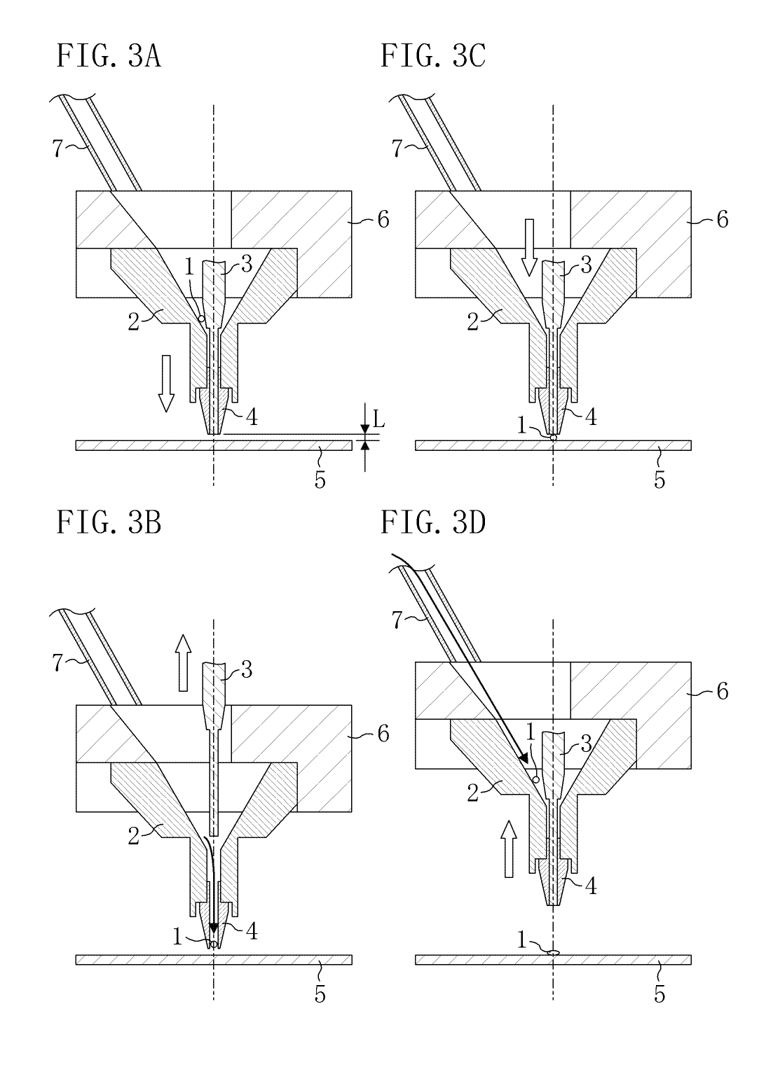

Next, a solder ball mounting method according to the embodiment of the present invention will be described with reference to FIGS. 3A-3D. FIGS. 3A-3D illustrate steps of the solder ball mounting method according to the embodiment of the present invention in the sequence in which a solder ball is mounted.

First, as shown in FIG. 3A, the solder ball 1 is supplied through the through pipe 7. The supplied solder ball 1 rolls toward the bottom part along the tapered shapes of the attachment block 6 and the hopper 2, and blocked by the pressing pin 3 to be stopped. The solder ball mounting apparatus moves to a position directly above the lead frame 5 mounting the solder balls 1, and goes down and stops above the lead frame 5 with a predetermined gap L therebetween. The lead frame 5 may be a substrate.

Next, as shown in FIG. 3B, when the pressing pin 3 starts to rise, the solder ball 1 rolls to the bottom portion of the hopper 2 without being caught by the pressing pin 3 because of the tapered shape of the tip of the pressing pin 3, and further rolls along the inner wall of the mounting head 4 to arrive at the tip of the mounting head 4. The movement of the solder ball 1 is controlled by the inner wall of the mounting head 4, and the solder ball 1 precisely arrives at a mounting position.

The inner diameter of the mounting head 4 is larger than the diameter of the solder ball 1 which has been used. It is necessary to choose the size of the inner diameter of the mounting head 4 depending on a size of the diameter of the solder ball 1 since the difference between the inner diameter of the mounting head 4 and the diameter of the solder ball 1 affects mounting precision. In the embodiment, the diameter of the solder ball 1 is φ0.9 mm, whereas the inner diameter of the mounting head 4 is φ1.3 mm.

Next, as shown in FIG. 3C, the solder ball 1 which has arrived at the tip of the mounting head 4 is mounted in a mounting position on the lead frame 5, and then, the solder ball 1 starts to melt from the contact portion.

The inner wall of the mounting head 4 controls the movement of the solder ball 1 which has precisely been mounted in the mounting position, whereby the pressing pin 3 falls toward the solder ball 1. The pressing pin 3 having fallen presses the solder ball 1 from the above on the lead frame 5 to facilitate melting of the solder ball 1. With this movement, the solder ball 1 is temporarily held so as not to roll.

In the embodiment, the diameter of the solder ball 1, the length of the gap L, and a part the pressing pin 3 for pressing are set to be φ0.9 mm, 0.4 mm, and 0.2 mm, respectively. It is necessary to choose optimum values depending on a material of the solder ball 1, a size of the inner diameter of the mounting head 4, and the like.

Next, as shown in FIG. 3D, the temporary holding of the solder ball 1 is completed, and the solder ball mounting apparatus rises to complete the mounting of the solder ball 1. The lead frame 5 is pitch-fed along with the rise of the solder ball mounting apparatus to prepare the next solder ball 1 for mounting.

At this time, in the solder ball mounting apparatus, even if the next solder ball 1 is supplied to the hopper 2, its path is blocked by the pressing pin 3 and the next solder ball 1 cannot pass through the mounting head 4, thereby making it possible to prepare the next operation, and shorten a duration of the mounting operation.

The above steps make it possible to feed the solder balls 1 one by one to the solder ball mounting apparatus, position the solder ball 1 for mounting and temporarily hold the solder ball 1. In other words, according to the solder ball mounting method regarding the embodiment, the inner wall of the mounting head 4 controls the movement of the solder ball 1, thereby precisely positioning the solder ball 1, while the pressing pin 3 presses the positioned solder ball 1. Then, the solder ball 1 is encouraged to melt, and is temporarily held, and therefore, the solder ball 1 can be mounted without rolling and being shifted after the solder ball 1 is mounted.

In the embodiment, the hopper including a mortar shaped upper portion whose inner diameter becomes smaller downwardly, and a cylindrical lower portion having a fixed inner diameter is used as an example. The mortar shaped upper portion is not limited to this shape, and it may have any shape.

In the embodiment, the solder ball is used as an example. However, a metal ball except the solder ball may also be applicable. For instance, an Au ball, Cu ball, etc. may be used as other examples of the metal ball.

In the embodiment, the nitrogen gas is used as a gas for preventing the solder ball 1 from being oxidized. The gas is not limited to this, and green gas, etc. may be used as other examples of the gas.

The solder ball mounting apparatus, the solder ball mounting method, and the metal ball mounting apparatus according to the present invention can reliably and precisely mount solder balls which serve as metal balls one by one in mounting positions, and are useful for manufacturing facilities of semiconductor devices.

What is claimed is:

1. A solder ball mounting apparatus, comprising:
a hopper;
a mounting head provided at a tip of the hopper; and
a pressing pin which is insertable inside the hopper and the mounting head, wherein
the mounting head has an inner diameter which restricts movement of solder balls, and
when one of the solder balls is supplied to the mounting head through the hopper, the pressing pin presses the one of the solder balls, thereby mounting the solder balls one by one on a target member.

2. The apparatus of claim 1, wherein
central positions of the hopper, the mounting head, and the pressing pin are identical with one another.

3. The apparatus of claim 1, wherein
the pressing pin is formed so as to close an inside of the hopper when the pressing pin goes down.

4. The apparatus of claim 3, wherein
the pressing pin is formed in a tapered shape so that a diameter of the pressing pin is smaller at a side of the mounting head.

5. The apparatus of claim 1, further comprising
a gas supply means configured to supply nitrogen gas to the hopper.

6. The apparatus of claim 1, further comprising:
an attachment block configured to attach the hopper; and
a heater provided in the attachment block.

7. A solder ball mounting method, comprising:
allowing a pipe having an inner diameter which restricts movement of solder balls to pass one of the solder balls;
mounting the one of the solder balls having passed through the pipe in a mounting position in a target member;
pressing the mounted solder ball from an inside of the pipe; and
after the pressing the mounted solder ball, melting the solder ball to solder the target member.
